(19) United States
(12) Patent Application Publication
(10) Pub. No.: US 2025/0290467 A1
(43) Pub. Date: Sep. 18, 2025

(54) PROPULSION SYSTEM USING RAMJET BLEED AIR FOR GAS TURBINE COMBUSTION

(71) Applicant: General Electric Company, Evendale, OH (US)

(72) Inventors: Jeffrey D. Rambo, Mason, OH (US); Scott G. Edens, Milford, OH (US)

(21) Appl. No.: 19/222,251

(22) Filed: May 29, 2025

Related U.S. Application Data
(62) Division of application No. 18/065,137, filed on Dec. 13, 2022, now Pat. No. 12,331,703.

(51) Int. Cl. F02K 7/16

(52) U.S. Cl. CPC F02K 7/16; F05D 2220/10; F05D 2220/80

(57) ABSTRACT

A propulsion system includes a ramjet engine and a turbine engine configured for multimode operation. The turbine engine includes a compressor section, a combustor, and a turbine section, while the ramjet engine includes a ramjet bleed air passage. A combustor inlet flow control device positioned at an outlet end of the compressor section includes a bleed valve having a ramjet bleed air inlet, a compressor bleed air outlet, and a flow control element rotatable between two positions. In a first position, the flow control device directs compressor bleed air to the turbine engine combustor. In a second position, the flow control device restricts compressor air and directs ramjet bleed air to the combustor. This configuration enables continued operation of the turbine section to drive engine accessories using ramjet-supplied air during high-speed flight when the compressor is inactive. A corresponding method for regulating airflow based on operational state is also disclosed.

### CROSS REFERENCE TO RELATED APPLICATIONS

This application is a divisional of U.S. patent application Ser. No. 18/065,137, filed Dec. 13, 2022, the entire contents of which are hereby incorporated by reference herein.

### TECHNICAL FIELD

The present disclosure relates to a propulsion system that uses ramjet bleed air for gas turbine combustion.

### BACKGROUND

An aircraft may include a propulsion system, such as a gas turbine engine, a ramjet engine, or a scramjet engine. Aircraft that may be designed for a high Mach number may include a combined propulsion system that includes, for example, a gas turbine engine for low Mach number operations and a ramjet engine for high Mach number operations. Such a combined propulsion system may cut off airflow to the gas turbine engine, and generally shutdown the gas turbine engine once the ramjet engine is ignited and operational. The gas turbine engine may be made operational once again when the airspeed decreases to an acceptable level for operation of the gas turbine engine.

### BRIEF DESCRIPTION OF THE DRAWINGS

Features and advantages of the present disclosure will be apparent from the following description of various exemplary embodiments, as illustrated in the accompanying drawings, wherein like reference numbers generally indicate identical, functionally similar, and/or structurally similar elements.

FIG. 1 is a top rear perspective view of an exemplary aircraft in which the propulsion system of the present disclosure may be implemented, according to an aspect of the present disclosure.

FIG. 2 is a schematic block layout of an exemplary propulsion system, according to an aspect of the present disclosure.

FIG. 3A is an enlarged cross-sectional view of a combustor inlet flow control device, taken at detail view 68 of FIG. 2, depicting a first position of flow controls doors according to an aspect of the present disclosure.

FIG. 3B is an enlarged cross-sectional view of a combustor inlet flow control device, taken at detail view 68 of FIG. 2, depicting a second position of flow control doors according to an aspect of the present disclosure.

FIG. 4 is a partial cross-sectional view of the combustor inlet flow control device, taken at plane 4-4 of FIG. 3, according to an aspect of the present disclosure.

FIG. 5 is an aft forward-looking perspective view of a combustor inlet flow control device depicting flow control doors in an open position, according to an aspect of the present disclosure.

FIG. 6A and FIG. 6B depict an alternate example of a combustor inlet flow control device, according to another aspect of the present disclosure.

FIG. 7 is a schematic block layout of the propulsion system of FIG. 2, but depicted in a second (high speed) operating state, according to an aspect of the present disclosure.

FIG. 8 is a schematic block layout of the propulsion system similar to that of FIG. 7, according to another aspect of the present disclosure.

FIG. 9 is a schematic block layout of the propulsion system similar to that of FIG. 7, according to another aspect of the present disclosure.

FIG. 10 is a flow chart of process steps for a method of operating a propulsion system, according to an aspect of the present disclosure.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed.

Various embodiments are discussed in detail below. While specific embodiments are discussed, this is done for illustration purposes only. A person skilled in the relevant art will recognize that other components and configurations may be used without departing from the spirit and the scope of the present disclosure.

The terms “upstream” and “downstream” refer to the relative direction with respect to fluid flow in a fluid pathway. For example, “upstream” refers to the direction from which the fluid flows, and “downstream” refers to the direction to which the fluid flows.

An aircraft may include a propulsion system, such as a gas turbine engine, a ramjet engine, or a scramjet engine. Aircraft that may be designed for a high Mach number may include a combined propulsion system that includes, for example, a gas turbine engine for low Mach number operations and a ramjet engine for high Mach number operations. Such a combined propulsion system may cut off airflow to the gas turbine engine, and generally shutdown the gas turbine engine once the ramjet engine is ignited and operational. The gas turbine engine may be made operational once again when the airspeed decreases to an acceptable level for operation of the gas turbine engine.

The present disclosure provides a propulsion system that includes both a turbine engine and a ramjet jet engine or a scramjet engine in a manner that allows a turbine section of the gas turbine engine to remain operational during ramjet/scramjet propulsion so that the gas turbine engine can continue to drive various accessories (e.g., a generator, an oil system, or environmental systems). According to the present disclosure, in a high speed operating state, an inlet to the gas turbine engine may be closed-off so that inlet airflow is restricted from entering the inlet, and an outlet from a compressor of the gas turbine engine may be closed-off so that a high pressure outlet flow from the compressor does not flow downstream to a combustor of the gas turbine engine. Rather, ramjet bleed air from a ramjet inlet of the ramjet engine may be diverted from the ramjet inlet to the combustor of the gas turbine engine. The ramjet bleed air is mixed with fuel in the gas turbine combustor and burned so as to drive a turbine section of the gas turbine engine. The turbine section drives the compressor section, which, in turn, drives the accessories, such as an auxiliary generator to provide electrical power, for example, to the aircraft.

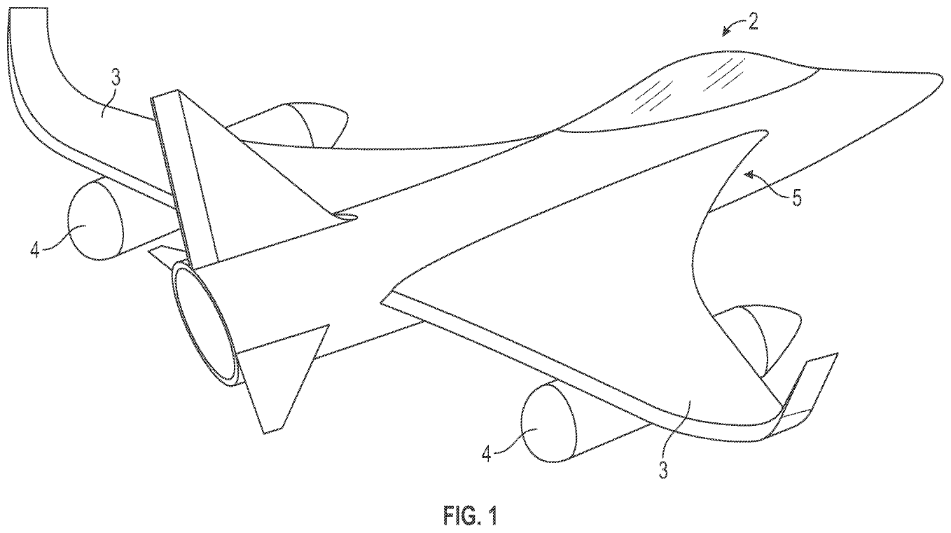

Referring now to the drawings, FIG. 1 is a perspective top rear view of an exemplary aircraft 2 (which may also be referred to as a flight vehicle) in which the propulsion system of the present disclosure may be implemented, according to an aspect of the present disclosure. The aircraft 2 of FIG. 1 may be designed for supersonic flight operations, or may be designed for hypersonic flight operations. As shown in FIG. 1, the aircraft 2 includes at least one propulsion system 4. In FIG. 1, two propulsion systems 4 are shown as being implemented in the aircraft 2, but fewer than two, or more than two, propulsion systems 4 may be implemented instead. In addition, FIG. 1 depicts the propulsion system 4 as generally being attached to an underside of a wing 3 of the aircraft 2, but the propulsion system 4 may be embedded within the wing 3 instead, or may be embedded within a fuselage 5 of the aircraft 2.

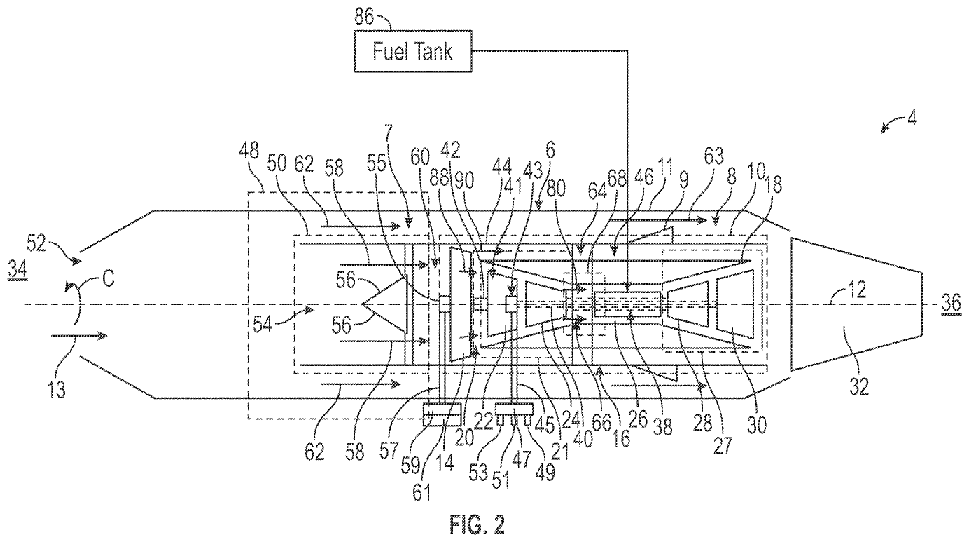

FIG. 2 is a schematic block layout of an exemplary propulsion system 4, according to an aspect of the present disclosure. The propulsion system 4 may include a ramjet engine 6 and a turbine engine 10. The turbine engine 10 may be, for example, a turbofan engine or a turbojet engine, as but a few examples. As shown in FIG. 2, propulsion system 4 has a longitudinal centerline axis 12 that extends therethrough from an upstream end 34 of the propulsion system 4 to a downstream end 36 of the propulsion system 4 for reference purposes. The longitudinal centerline axis 12 may also represent a longitudinal centerline axis of the ramjet engine 6 and/or a longitudinal centerline axis of the turbine engine 10. The ramjet engine 6 may generally be defined between a ramjet outer casing 11 of the propulsion system 4 and the turbine engine 10. In the FIG. 2 aspect, the ramjet engine 6 may extend circumferentially in a circumferential direction C about the longitudinal centerline axis 12, and the ramjet engine 6 may include a ramjet inlet portion 7 and a ramjet combustor 8. Thus, the ramjet engine 6 is arranged in parallel with the turbine engine 10. However, the ramjet engine 6 need not extend circumferentially about the turbine engine 10, and may be a separate engine defined by another shape (e.g., a square or rectangular shape) extending along at least a portion of the length of the turbine engine 10 that is arranged parallel with the turbine engine 10. As will be described in more detail below, a ramjet inlet airflow 62, which may constitute a portion of an inlet airflow 13 to the propulsion system 4, may pass through the ramjet inlet portion 7 to the ramjet combustor 8, where fuel may be injected by one or more ramjet fuel injectors 9 (two shown in FIG. 2) into the ramjet combustor 8 to mix with the ramjet inlet airflow 62 and to be ignited and burned to provide ramjet propulsion.

In FIG. 2, the turbine engine 10 is depicted as constituting a turbofan engine and, therefore, the following description will focus on a turbofan engine being included within the propulsion system 4. The turbine engine 10 may include a fan assembly 14 and a core engine 16 disposed downstream from the fan assembly 14. The core engine 16 may generally include a core engine outer casing 18 that defines an annular inlet 20. The core engine outer casing 18 encases, in serial flow relationship, a compressor section 21 that includes a low pressure (LP) compressor 22 and a high pressure (HP) compressor 24, a turbine engine combustor 26, a turbine section 27 that includes a high pressure (HP) turbine 28 and a low pressure (LP) turbine 30, and a jet exhaust nozzle section 32. The jet exhaust nozzle section 32 may be a shared nozzle that is shared between the turbine engine 10 and the ramjet engine 6. A high pressure (HP) shaft assembly 38 drivingly couples the HP turbine 28 to the HP compressor 24, and a low pressure (LP) shaft assembly 40 drivingly couples the LP turbine 30 to the LP compressor 22. Together, the low pressure compressor 22, the low pressure turbine 30, and the low pressure shaft assembly 40 may be referred to as a low pressure spool 41 that rotate together as one element. The low pressure spool 41 may further be coupled to the fan assembly 14 via a fan shaft 42, with the fan assembly 14 being arranged upstream of the compressor section 21. While not shown in FIG. 2, a reduction gearbox may be implemented within the fan shaft 42 between the low pressure compressor 22 and the fan assembly 14 so as to function as a speed reducer between the low pressure spool 41 and the fan assembly 14. Thus, in normal operation of the turbine engine 10, the low pressure spool 41 drives the fan assembly 14. In addition, the low pressure spool 41 may be connected with a gearbox 43 that is drivingly connected via a driveshaft 45 to an accessory gearbox 47. The accessory gearbox 47 may drive various accessory components, such as an oil pump 49, a fuel pump 51, a hydraulic pump 53, and other accessories that are not shown. The fan assembly 14 may also be drivingly connected to a gearbox 55 that is drivingly connected to an auxiliary gearbox 59 via a driveshaft 57. The auxiliary gearbox 59 may include various accessories connected therewith, including, for example, an auxiliary generator 61. A fan casing 44 circumferentially surrounds the fan assembly 14 and/or at least a portion of the core engine 16 so as to define a bypass airflow passage 46 therebetween.

The propulsion system 4 is further seen to include an inlet section 48 that includes the ramjet inlet portion 7 and a turbine engine inlet portion 50. As will be described below, the inlet section 48 takes in the inlet airflow 13 at a propulsion system inlet 52 and provides the inlet airflow 13 to both the ramjet engine 6 and to the turbine engine 10. The propulsion system 4 depicted in FIG. 2 is a general configuration of the propulsion system 4 in a first (low speed) operating state. In the FIG. 2 aspect, the turbine engine inlet portion 50 is shown as including a turbine engine inlet section restriction device 54 that may include a plurality of airflow inlet doors 56 that can be actuated between an open position and a closed position. FIG. 2 depicts the airflow inlet doors 56 in the open position so as to allow a turbine inlet airflow 58 to flow through a turbine engine inlet 60 and to the fan assembly 14. Another portion of the inlet airflow 13 flows into the ramjet inlet portion 7 as a ramjet inlet airflow 62. The ramjet engine 6 further includes at least one ramjet bleed air passage 64 that is in airflow communication with the turbine engine combustor 26 of the turbine engine 10. As will be described below, the ramjet bleed air passage 64 provides for a portion of the ramjet inlet airflow 62 to be able to flow into the turbine engine combustor 26 of the turbine engine 10 during a second (high speed) operating state of the propulsion system 4.

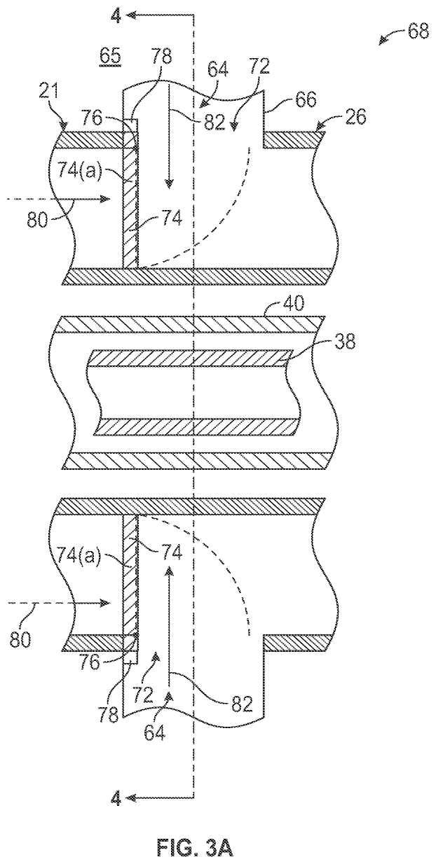

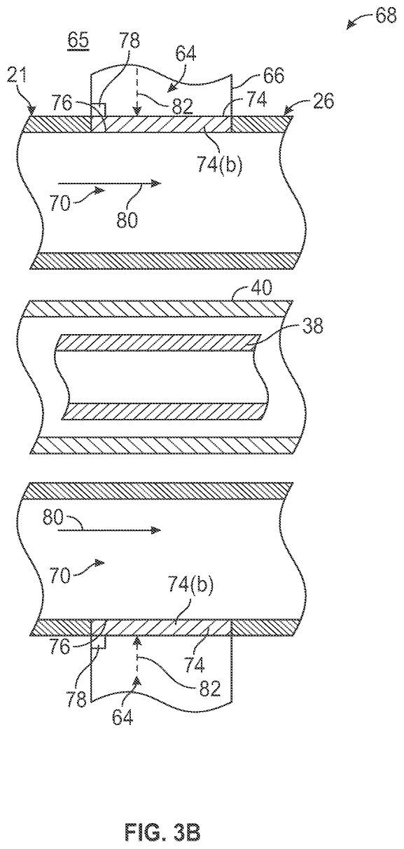

The propulsion system 4 of FIG. 2 further includes a combustor inlet flow control device 66. FIG. 3A and FIG. 3B are enlarged cross-sectional views of the combustor inlet flow control device 66 taken at detail view 68 of FIG. 2. The combustor inlet flow control device 66 is arranged between the compressor section 21 and the turbine engine combustor 26, and includes a plurality of axial flow passages 70 arranged between the compressor section 21 and the turbine engine combustor 26, and a plurality of ramjet bleed air passages 72 that are radial airflow passages. A plurality of flow control doors 74 control airflow through the respective axial flow passages 70 and through the respective ramjet bleed air passages 72. More particularly, as shown in FIG. 3A, the plurality of flow control doors 74 may be hinged doors having a hinge 76, and an actuator 78 may control rotation of the flow control doors 74 about the hinge 76. In one aspect, the actuator 78 may be a torsion spring that, in a resting state, applies a torsional force to rotate the flow control door 74 to the position shown as flow control door 74(a) in FIG. 3A to close-off the axial flow passages 70. Alternatively, the actuator 78 may be a hydraulic or a pneumatic actuator that controls the rotation of the flow control doors 74. The position shown as the flow control door 74(a) may be referred to as a “closed position.” In operation, when the turbine engine 10 is started-up in the first (low speed) operating state, pressure from compressed air 80 flowing from the compressor section 21 may apply a force (e.g., pressure-differential) against the flow control door 74 to force to flow control door 74 from the closed position (flow control door 74(a) in FIG. 3A) to an open position, shown as flow control door 74(b) in FIG. 3B, so as to open the axial flow passage 70 and to allow the compressed air 80 to flow to the turbine engine combustor 26. When the flow control doors 74 are actuated to the open position as shown in FIG. 3B, the ramjet bleed air passages 72 are closed off so that a ramjet inlet bleed airflow 82 is restricted from passing through the ramjet bleed air passages 72.

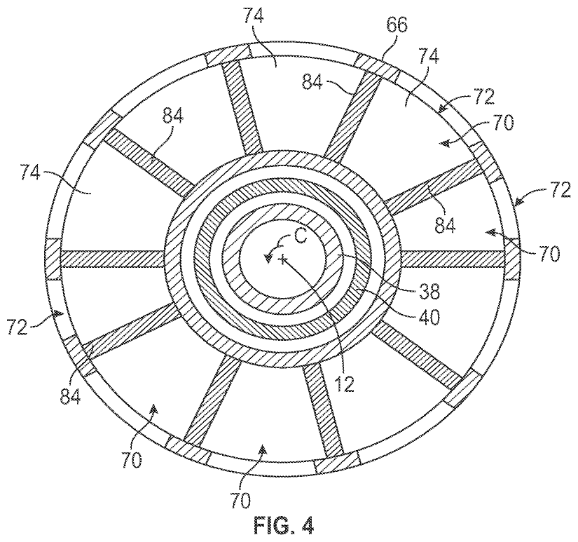

FIG. 4 is a partial cross-sectional view of the combustor inlet flow control device 66, taken at plane 4-4 of FIG. 3, according to an aspect of the present disclosure. As shown in FIG. 4, the combustor inlet flow control device 66 may include a plurality of circumferentially spaced guide vanes 84. The axial flow passages 70 are defined between the guide vanes 84, and the flow control doors 74 are arranged between the guide vanes 84. In addition, respective ones of the plurality of ramjet bleed air passages 72 are circumferentially aligned about the longitudinal centerline axis 12 with respective ones of the plurality of axial flow passages 70.

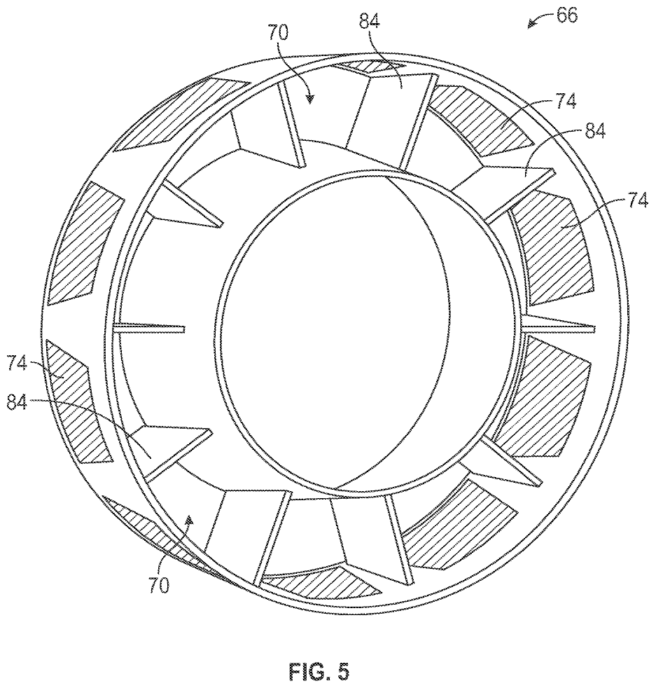

FIG. 5 is an aft forward-looking perspective view of the combustor inlet flow control device 66, depicting the flow control doors 74 in the open position (i.e., opening the axial flow passages 70 and closing the ramjet bleed air passages 72). While FIGS. 3A, 3B, 4 and 5 depict the combustor inlet flow control device 66 as including the flow control doors 74 for controlling the flow of the compressed air 80 from the compressor section 21 to the turbine engine combustor 26, and for controlling the ramjet inlet bleed airflow 82 to the turbine engine combustor 26, other configurations may be implemented instead. For example, rather than including the flow control doors 74, the guide vanes 84 may be made rotatable to control the airflow to the turbine engine combustor 26.

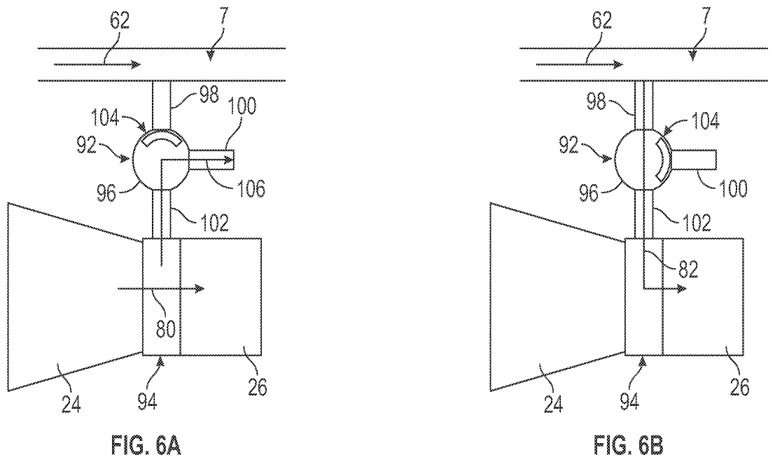

FIG. 6A and FIG. 6B depict an alternate example of a combustor inlet flow control device, according to another aspect of the present disclosure. In FIG. 6A and FIG. 6B, a combustor inlet flow control device 92 may constitute a part of a compressor bleed air system arranged at an outlet end 94 of the high pressure compressor 24. The combustor inlet flow control device 92 may include a bleed valve 96 having a ramjet bleed air inlet 98, a compressor bleed air outlet 100, and a bleed valve connector 102 connecting the bleed valve 96 with the outlet end 94 of the high pressure compressor 24. A flow control device (or a valve plate) 104 controls the flow of air through the bleed valve 96. FIG. 6A depicts an arrangement of the flow control device 104 in the first (low speed) operating state of the propulsion system 4. As was discussed above for FIG. 2, the turbine engine 10 is made operational in the first operating state, and compressed air 80 is provided from the high pressure compressor 24 to the turbine engine combustor 26. Thus, in the first (low speed) operating state, the flow control device 104 is arranged to restrict (i.e.,block) the ramjet bleed air inlet 98, thereby permitting the compressed air 80 to flow to the combustor 26. In addition, in the first operating state, the flow control device 104 allows a flow of compressor bleed air 106 to flow through the compressor bleed air outlet 100. The compressor bleed air 106 may be utilized for various operations of the propulsion system 4, and/or the aircraft 2, such as for cooling various engine components of the propulsion system 4, and/or for environmental control within the aircraft 2. FIG. 6B, on the other hand, depicts an arrangement of the flow control device 104 in the second (high speed) operating state of the propulsion system 4. In FIG. 6B, the flow control device 104 is rotated to restrict (i.e., block, or at least partially block) the compressor bleed air outlet 100, and to open the ramjet bleed air inlet 98 to allow the ramjet inlet bleed airflow 82 to flow through the bleed valve 96 and to the turbine engine combustor 26. In the second operating state, when the compressor section may be made inactive, the pressure from the ramjet inlet bleed airflow 82 may restrict the compressed air 80 from flowing to the combustor 26.

In an alternate arrangement, although not shown in the figures, the combustor inlet flow control device 92 may be arranged within the high pressure compressor 24 (i.e., between compressor stages within the high pressure compressor 24) rather than being arranged with the outlet end 94 of the high pressure compressor 24. In this case, the flow control device 104 could be rotated between the position shown in FIG. 6A and the position shown in FIG. 6B so as to allow some of the compressor bleed air 106 from the high pressure compressor 24 to pass through the compressor bleed air outlet 100, while also allowing some of the ramjet inlet bleed air 82 to flow through the compressor bleed air outlet 100. This would generally be in the first (low speed) operating state so as to allow some compressor bleed air 106 from the high pressure compressor 24 to bleed off of the high pressure compressor 24 for operability of the engine 10 under certain conditions.

Referring back to FIG. 2, the propulsion system 4 includes a fuel tank 86. The fuel tank 86 may be arranged within the wings 3 or the fuselage 5 of the aircraft 2 (see FIG. 1), and stores a fuel for operation of the ramjet engine 6 and the turbine engine 10. In operation of the propulsion system 4 in the first (low speed) operating state, the inlet airflow 13 is provided through the propulsion system inlet 52 to the propulsion system 4. The turbine engine inlet section restriction device 54 is actuated to the open state, such that the airflow inlet doors 56 are arranged as shown in FIG. 2. The turbine inlet airflow 58 is therefore permitted to flow to the turbine engine inlet 60 and to the fan assembly 14. A core engine inlet airflow 88 flows through the annular inlet 20 into the compressor section 21, where it is compressed to generate the compressed air 80. The flow control doors 74 are actuated to the open position (FIG. 3) and the compressed air 80 flows through the axial flow passages 70 (FIG. 3) of the combustor inlet flow control device 66 to the turbine engine combustor 26. The flow control doors 74 being in the open position close off the ramjet bleed air passages 72. Fuel from the fuel tank 86 is provided to the turbine engine combustor 26, and the fuel is mixed with the compressed air 80 to generate a fuel/air mixture that is ignited and burned in the turbine engine combustor 26. Combustion gases from the burned fuel/air mixture flow from the turbine engine combustor 26 to the turbine section 27, thereby causing the high pressure turbine 28 and the low pressure turbine 30 to rotate. The rotation of the high pressure turbine 28 drives the high pressure compressor 24, and the rotation of the low pressure turbine 30 drives the low pressure compressor 22.

The rotation of the low pressure compressor 22 drives the gearbox 43, which in turn drives the accessory gearbox 47 via the driveshaft 45 so as to drive the accessories (e.g., the oil pump 49, the fuel pump 51, and the hydraulic pump 53). Similarly, the rotation of the low pressure compressor 22 drives the fan assembly 14. In the first (low speed) operating state, the gearbox 55 may be disengaged from the auxiliary gearbox 59 via, for example, a clutch device (not shown) between the gearbox 55 and the auxiliary gearbox 59. The combustion gases then exit the turbine section 27 to the jet exhaust nozzle section 32 to provide propulsive thrust.

The fan assembly 14 further provides a bypass airflow 90 to the bypass airflow passage 46, thereby providing the main thrust of the turbine engine 10. In the first operating state, the ramjet engine 6 may be passive and, therefore, the ramjet inlet airflow 62 may merely pass through the ramjet inlet portion 7 and the ramjet combustor 8 as a bypass airflow. Alternatively, once a predetermined Mach number has been reached (e.g., Mach 2.0, for example), the ramjet engine 6 may be made active such that fuel from the fuel tank 86 (or fuel from a different fuel tank for a case where the turbine engine 10 and the ramjet engine 6 may operate using different fuels) is provided to the ramjet fuel injector 9 to generate a fuel/air mixture in the ramjet combustor 8 that is then ignited and burned to generate combustion gases 63 that exit the ramjet combustor 8 and may flow to the jet exhaust nozzle section 32 to provide ramjet thrust.

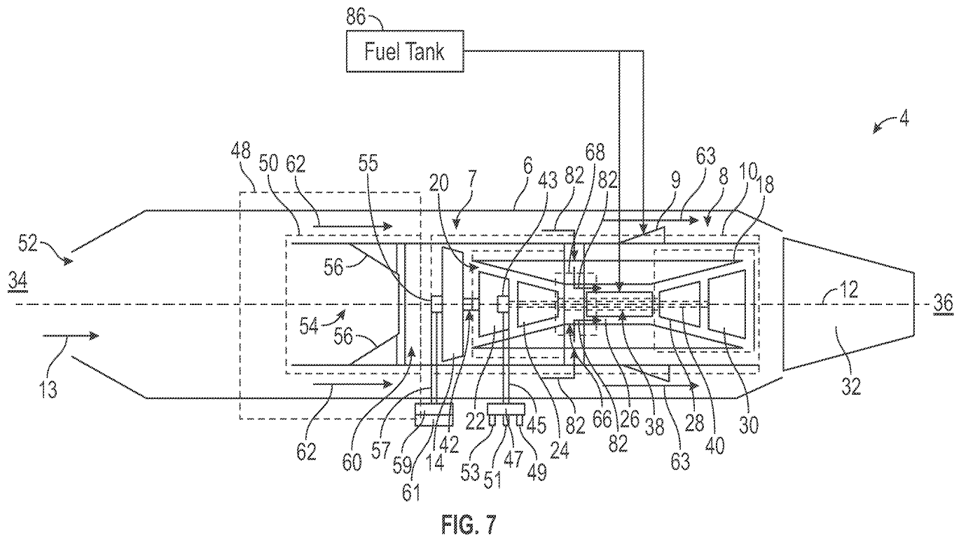

FIG. 7 is a schematic block layout of the propulsion system of FIG. 2, but depicted in the second (high speed) operating state, according to another aspect of the present disclosure. In FIG. 7, elements that are the same as those of FIG. 2 are shown with the same reference numerals. In the FIG. 7 aspect, the second operating state may be a high speed operating state, such as an operating state for a flight speed of the aircraft 2 of greater than Mach 2.0, or greater than Mach 2.5, for example. In the second (high speed) operating state of FIG. 7, the ramjet engine 6 is active to be the primary source of thrust for the propulsion system 4. Thus, fuel from the fuel tank 86 is provided to the ramjet fuel injector 9 to mix with the ramjet inlet airflow 62 in the ramjet combustor 8, and the resulting fuel/air mixture is ignited and burned to generate ramjet thrust. Of course, there may be a transitional operating state between the first (low speed) operating state and the second (high speed) operating state where the engine configuration transitions from that of the FIG. 2 aspect to that of the FIG. 7 aspect. Such a transitional operating state may occur, for example, between Mach 2.0 and Mach 3.0, as one example.

With regard to the turbine engine 10, in the second (high speed) operating state, the fan assembly 14 and the compressor section 21 may be closed-off (or cocooned), while the turbine engine combustor 26 and the turbine section 27 may remain active in order to drive the accessory gearbox 47 and/or the auxiliary gearbox 59. Therefore, the turbine engine inlet section restriction device 54 is actuated to the closed position so as to restrict the turbine inlet airflow 58 (FIG. 2) from flowing to the turbine engine inlet 60. For example, the airflow inlet doors 56 may be actuated to the closed position as shown in FIG. 7, as compared to the open state shown in FIG. 2, so as to block the turbine inlet airflow 58. The combustor inlet flow control device 66 may be actuated such that the flow control doors 74 are in the closed position (flow control door 74(a) of FIG. 3) so as to close-off the axial flow passages 70 and to open the ramjet bleed air passages 72. Thus, the fan assembly 14 and the compressor section 21 may be considered to be closed-off (or cocooned) from the inlet airflow 13, while the ramjet inlet bleed airflow 82 is permitted to flow through the ramjet bleed air passages 72 (FIG. 3) and into the turbine engine combustor 26. Fuel is provided to the turbine engine combustor 26, where the fuel is mixed with the ramjet inlet bleed airflow 82 to generate a fuel/air mixture that is ignited and burned to generate combustion gases. In the same manner described above, the combustion gases flow through the turbine section 27, causing the high pressure turbine 28 and the low pressure turbine 30 to rotate, which in turn causes the high pressure compressor 24 and the low pressure compressor 22 to rotate. The rotation of the low pressure compressor 22 drives the gearbox 43, which drives the accessory gearbox 47 via the driveshaft 45, thereby operating the accessories connected to the accessory gearbox 47. Similarly, the rotation of the low pressure compressor 22 may cause the fan assembly 14 to rotate, thereby driving the gearbox 55, which drives the auxiliary gearbox 59 via the driveshaft 57, thereby operating the auxiliary generator 61. Since the fan assembly 14 and the compressor section 21 are cocooned, but are driven by the turbine section 27 in the second operating state, some airflow within the compressor section 21 may be generated, and the resulting airflow within the compressor section 21 may merely be bled out tof the compressor section 21 via a bleed valve (not shown). As a result, when the propulsion system 4 is operated in the second (high speed) operating state, the turbine engine 10 can continue to operate using the ramjet inlet bleed airflow 82 in order to drive the accessories and/or the auxiliary generator.

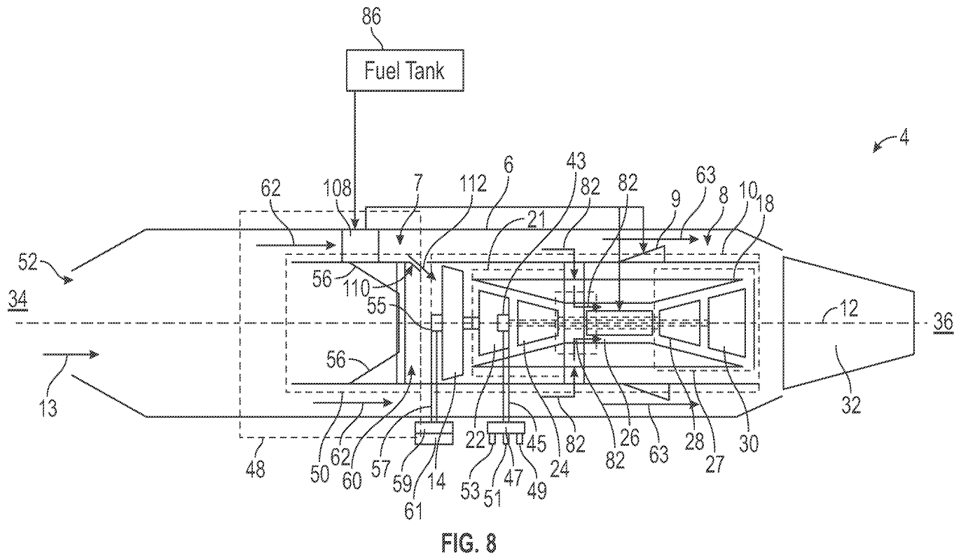

FIG. 8 is a schematic block layout of the propulsion system similar to that of FIG. 7, according to another aspect of the present disclosure. In FIG. 8, elements that are the same as those of FIG. 7 are shown with the same reference numerals. One difference between the FIG. 7 aspect and the FIG. 8 aspect is that the propulsion system 4 in FIG. 8 includes a heat exchanger 108, which may be arranged in the ramjet inlet 7, to cool a portion of the ramjet inlet airflow 62. The turbine engine inlet 60 also includes at least one cooled airflow passage 110. Fuel from the fuel tank 86 may flow through the heat exchanger 108 prior to being provided to the turbine engine combustor 26 and/or to the ramjet fuel injector 9. The fuel may provide for cooling the ramjet inlet airflow 62 and a cooled inlet air 112 that is generated by the heat exchanger 108 is provided to the turbine engine inlet 60. Thus, with the FIG. 8 aspect, the cooled inlet air 112 can help to purge the closed off compressor section 21 in the second (high speed) operating state.

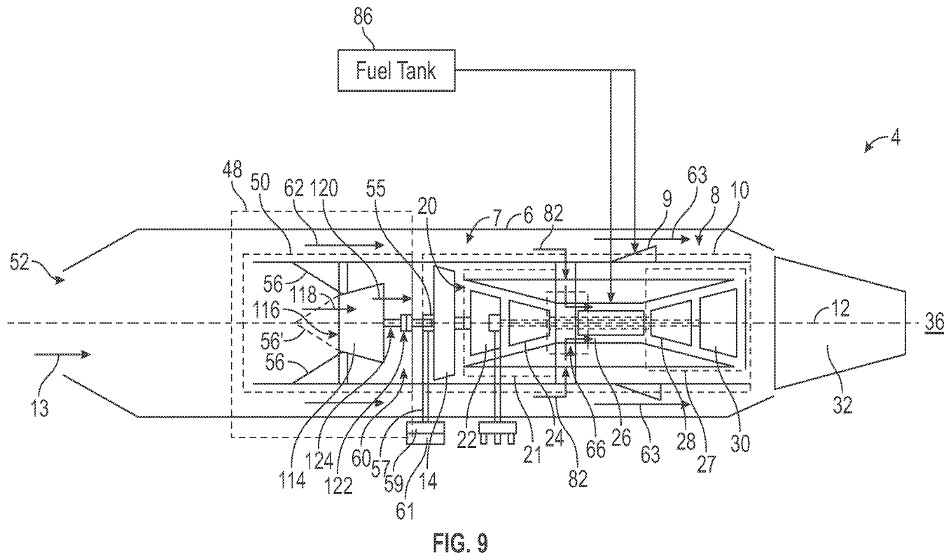

FIG. 9 is a schematic block layout of the propulsion system similar to that of FIG. 7, according to another aspect of the present disclosure. In FIG. 9, elements that are the same as those of FIG. 7 are shown with the same reference numerals. One difference between the FIG. 7 aspect and the FIG. 9 aspect is that the turbine engine inlet portion 50 in FIG. 9 includes an expansion turbine 114 that includes an expansion turbine inlet 116. The expansion turbine inlet 116 takes in an inlet airflow 118 and expands the inlet airflow 118 to provide cooling to the inlet airflow 118. In the first (low speed) operating state, the expansion turbine inlet 116 may be blocked by the airflow inlet doors 56 when airflow inlet doors 56 are in a open position (i.e. open to allow the inlet airflow 13 to bypass the expansion turbine 114 and to flow to the turbine engine inlet 60). For reference purposes, the airflow inlet doors 56′ are shown in dashed lines in the open position for the first (low speed) operating state. When airflow inlet doors 56 are in a closed position as shown in FIG. 9, the inlet airflow 118 is permitted to flow to the expansion turbine 114 and a cooled inlet airflow 120 from the expansion turbine 114 may then be provided to the fan assembly 14 and to the annular inlet 20 of the core engine 16 so as to provide some cooling to the compressor section 21 during the second (high speed) operating state.

The expansion turbine 114 may be drivingly connected with the fan assembly 14 and/or the gearbox 55 via a driveshaft 124, which may include a clutch device 122. In the first (low speed) operating state, the clutch device 122 may be disengaged, while in the second (high speed) operating state, the clutch device 122 may be engaged so that the expansion turbine 114 provides some rotational force to the gearbox 55, and by virtue of the gearbox 55 being drivingly connected with the auxiliary gearbox 59, can drive the auxiliary gearbox 59 and the auxiliary generator 61. Additionally, by virtue of the driving connection from the fan assembly 14 to the low pressure compressor 30, the expansion turbine 114 can provide some rotational work to the low pressure spool 41 to relieve some of the work required by the low pressure compressor 30.

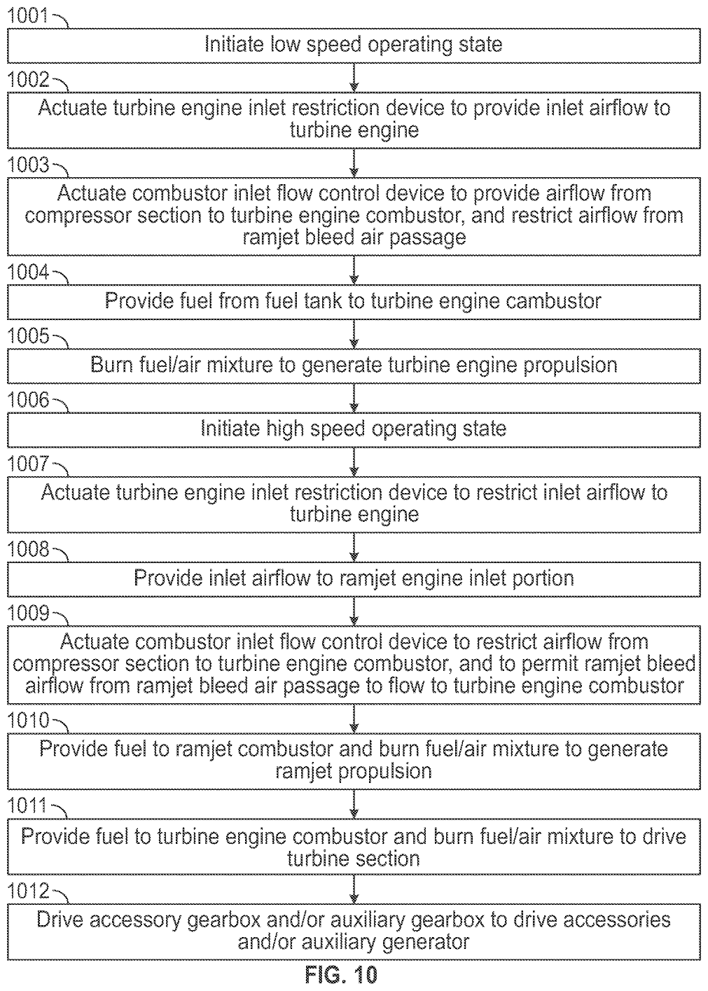

FIG. 10 is a flow chart of process steps for a method of operating the propulsion system 4, according to an aspect of the present disclosure. The method of operating the propulsion system 4 may be implemented in any of the foregoing aspects of FIG. 1 to FIG. 9. In the method, when the propulsion system 4 is first started-up, a low speed operating state is initiated in step 1001. In the low speed operating state, in step 1002, as shown in FIG. 2, for example, the turbine engine inlet section restriction device 54 is actuated to permit the turbine inlet airflow 58 to flow to the turbine engine inlet 60 of the turbine engine 10. As was described above for FIG. 2, the airflow inlet doors 56 may be actuated to the open position to allow the turbine inlet airflow 58 to flow into the turbine engine inlet 60. In step 1003, the combustor inlet flow control device 66 is actuated to provide the compressed air 80 from the compressor section 21 to the turbine engine combustor 26, and to restrict the ramjet inlet bleed airflow 82 from passing through the ramjet bleed air passages 72. As was described above in FIG. 3, the flow control doors 74 may be actuated to control the airflow to the turbine engine combustor 26. In step 1004, fuel is provided from the fuel tank 86 to the turbine engine combustor 26, and, as was described above, in step 1005, the fuel/air mixture is burned to generate combustion gases and to provide turbine engine propulsion. In addition, as was described above, the ramjet engine 6 may be passive in the first operating state and the ramjet inlet airflow 62 may merely pass through the ramjet engine 6 as a bypass airflow.

Once a desired flight speed is reached by the aircraft 2 (e.g., about Mach 2.5, or as the aircraft may be approaching Mach 2.5, such as Mach 2.0, or Mach 1.5), in step 1006, the second (high speed) operating state is initiated. In step 1007, the turbine engine inlet section restriction device 54 is actuated to restrict the turbine inlet airflow 58 from flowing to the turbine engine inlet 60 of the turbine engine 10. As was described above for FIG. 7, the airflow inlet doors 56 may be actuated to the closed position to restrict the turbine inlet airflow 58 from flowing into the turbine engine inlet 60. In step 1008, the ramjet inlet airflow 62 is provided to the ramjet inlet 7. In step 1009, the combustor inlet flow control device 66 is actuated to restrict the airflow from the compressor section 21 from flowing to the turbine engine combustor 26, and to permit the ramjet inlet bleed airflow 82 to pass through the ramjet bleed air passages 72 and into the turbine engine combustor 26. As was described above with respect to the FIG. 3 aspect, the flow control doors 74 may be actuated to the closed position (flow control door 74(a)) to control the airflow to the turbine engine combustor 26 from the ramjet inlet bleed air passages 72.

In step 1010, fuel is provided from the fuel tank 86 to the ramjet fuel injector 9 to mix with the ramjet inlet airflow 62, and the fuel/air mixture is ignited and burned in the ramjet combustor 8 to generate ramjet propulsion. In step 1011, fuel is provided from the fuel tank 86 to the turbine engine combustor 26 to mix with the ramjet inlet bleed airflow 82, and the fuel/air mixture is burned in the turbine engine combustor 26 to drive the turbine section 27. In step 1012, as was described above with regard to FIG. 7, the driving of the low pressure turbine 30 of the turbine section 27 in the high-speed operating state causes the low pressure compressor 22 to rotate, which in turn drives the accessory gearbox 47 that drives the accessories connected thereto. When the auxiliary gearbox 59 is included, the driving of the low pressure turbine 30 may also drive the fan assembly 14, which in turn drives the auxiliary gearbox 59, so as to drive the auxiliary generator 61. Thus, the method provides for the ability of the turbine engine 10 to be operated in the high speed operating state in order to drive the accessories, while the ramjet engine 6 may be operated as the primary source of propulsion.

Further aspects of the present disclosure are provided by the subject matter of the following clauses.

A propulsion system comprises a turbine engine including a turbine engine inlet, a compressor section, a turbine engine combustor, and a turbine section, a ramjet engine including a ramjet inlet portion having at least one ramjet bleed air passage in airflow communication with the turbine engine combustor, and a ramjet combustor, a turbine engine inlet section restriction device arranged to permit an inlet airflow to the turbine engine inlet in a first operating state of the propulsion system, and to restrict the inlet airflow to the turbine engine inlet in a second operating state of the propulsion system, a combustor inlet flow control device that, in the first operating state, (a) provides an airflow from the compressor section to the turbine engine combustor, and (b) restricts an airflow from flowing from the ramjet bleed air passages to the turbine engine combustor, and, in the second operating state, (c) provides a ramjet inlet bleed airflow from the at least one ramjet bleed air passage to the turbine engine combustor, and at least one accessory gearbox drivingly connected with the compressor section and including at least one accessory component that is driven accessory gearbox.

The propulsion system according to the preceding clause, in the first operating state, (i) the turbine engine inlet section restriction device permitting the inlet airflow to flow to the turbine engine inlet, (ii) the combustor inlet flow control device permits the airflow to flow from the compressor section to the turbine engine combustor, and restricts the ramjet inlet bleed airflow from flowing through the ramjet bleed air passages to the turbine engine combustor, and (iii) the turbine engine combustor is provided with fuel to generate turbine engine combustion that drives the turbine section, and to provide turbine engine propulsion, and in the second operating state, (iv) the turbine engine inlet section restriction device restricts the inlet airflow from flowing to the turbine engine inlet, (v) the combustor inlet flow control device restricts the airflow from flowing from the compressor section to the turbine engine combustor, and permits the ramjet inlet bleed airflow to flow through the ramjet bleed air passages to the turbine engine combustor, (vi) the turbine engine combustor is provided with fuel to generate turbine engine combustion that drives the turbine section, (vii) the turbine section drives the compressor section, which in turn drives the at least one accessory gearbox to operate the at least one accessory component, and (viii) the ramjet combustor is provided with fuel to provide ramjet engine propulsion.

The propulsion system according to any preceding clause, in the first operating state, the turbine engine being operational as a primary propulsion source and the ramjet engine is passive, and, in the second operating state, the ramjet engine is operational as the primary propulsion source and, in the turbine engine, the turbine engine combustor and the turbine section of the turbine engine are operational via the ramjet inlet bleed airflow so as to drive the compressor section and the at least one accessory gearbox for providing accessory services.

The propulsion system according to any preceding clause, the combustor inlet flow control device comprising an airflow bleed valve arranged at a downstream end of the compressor section, the airflow bleed valve including a ramjet bleed air inlet passage, a compressor bleed air outlet passage, and a flow control device, in the first operating state, the flow control device is actuated to close the ramjet bleed air inlet passage and to open the compressor bleed air outlet passage, and, in the second operating state, the flow control device is actuated to open the ramjet bleed air inlet passage so as to permit the ramjet inlet bleed airflow to flow through the combustor inlet flow control device to the turbine engine combustor and to close the compressor bleed air outlet passage.

The propulsion system according to any preceding clause, in the second operating state, the combustor inlet flow control device further providing a flow of ramjet inlet bleed airflow to the turbine section.

The propulsion system according to any preceding clause, the combustor inlet flow control device being arranged between the compressor section and the turbine engine combustor, and includes a plurality of axial airflow passages arranged between the compressor section and the turbine engine combustor, and a plurality of ramjet bleed air passages that are radial airflow passages, respective ones of the plurality of axial airflow passages being circumferentially aligned with respective ones of the plurality of ramjet bleed air passages.

The propulsion system according to any preceding clause, the combustor inlet flow control device including a plurality of flow control doors, each respective flow control door controlling the airflow through a respective axial airflow passage and controlling the airflow through a respective ramjet bleed air passage.

The propulsion system according to any preceding clause, in the second operating state, the plurality of flow control doors being actuated to a closed position with respect to the axial airflow passages, thereby restricting the airflow from flowing from the compressor section to the turbine engine combustor, and, to an open position with respect to the ramjet bleed air passages, thereby permitting the ramjet inlet bleed airflow to flow through the ramjet bleed air passages to the turbine engine combustor.

The propulsion system according to any preceding clause, in the first operating state, the plurality of flow control doors being actuated to an open position with respect to the axial airflow passages, thereby permitting the airflow to flow from the compressor section to the turbine engine combustor, and, to a closed position with respect to the ramjet bleed air passages, thereby restricting the ramjet inlet bleed airflow from flowing through the ramjet bleed air passages to the turbine engine combustor.

The propulsion system according to any preceding clause, in the first operating state, the plurality of flow control doors being actuated by a high pressure airflow generated by the compressor section.

The propulsion system according to any preceding clause, the first operating state of the propulsion system being a low speed operating state, and the second operating state of the propulsion system is a high speed operating state.

The propulsion system according to any preceding clause, the low speed operating state being an operating state of an airspeed up to Mach 2.5, and the high speed operating state is an operating state of an airspeed above Mach 2.5.

The propulsion system according to any preceding clause, further comprising a heat exchanger arranged in the ramjet inlet portion and arranged to cool a portion of a ramjet inlet airflow, and at least one cooled air flow passage that, in the second operating state, provides a flow of cooled inlet air that is generated by the heat exchanger to the turbine engine inlet.

The propulsion system according to any preceding clause, further comprising a fuel storage tank in fluid communication with the heat exchanger, the ramjet inlet airflow being cooled by fuel flowing from the fuel storage tank through the heat exchanger.

The propulsion system according to any preceding clause, the turbine engine further comprising an expansion turbine arranged at the turbine engine inlet, and, in the second operating state, the expansion turbine provides a cooled inlet airflow to the compressor section.

The propulsion system according to any preceding clause, the expansion turbine being drivingly connected with an auxiliary gearbox that drives an auxiliary component.

The propulsion system according to any preceding clause, the auxiliary component being an auxiliary generator.

The propulsion system according to any preceding clause, wherein the combustor inlet flow control device comprised a plurality of guide vanes, each respective guide vane being rotatable to an open position and to a closed position, the open position permitting the flow of compressed air from the compressor section to flow to the turbine combustor, and the closed position restricting the flow of compressed air from the compressor section from flowing to the turbine combustor.

The propulsion system according to any preceding clause, further including a fuel tank, wherein fuel is provided from the fuel tank to at least one of the turbine engine combustor and/or to a ramjet fuel injector of the ramjet engine.

The propulsion system according to any preceding clause, wherein, in the first operating state, the fuel is provided from the fuel tank to the turbine engine combustor, and in the second operating state, the fuel is provided to the turbine engine combustor and to the ramjet fuel injector.

The propulsion system according to any preceding clause, further including a heat exchanger arranged in the ramjet inlet portion, the fuel tank being in fluid communication with the heat exchanger, the fuel flowing through the heat exchanger and being provided to at least one of the turbine engine combustor and/or the ramjet fuel injector.

A method of operating a propulsion system, the propulsion system including (i) a turbine engine including a turbine engine inlet, a compressor section, a turbine engine combustor, and a turbine section, (ii) a ramjet engine arranged in parallel with the turbine engine, the ramjet engine including a ramjet inlet portion having at least one ramjet bleed air passage in airflow communication with the turbine engine combustor, and a ramjet combustor, (iii) a turbine engine inlet section restriction device arranged to permit an inlet airflow to the turbine engine inlet in a first operating state of the propulsion system, and to restrict the inlet airflow to the turbine engine inlet in a second operating state of the propulsion system, (iv) a combustor inlet flow control device that, in the first operating state, (a) provides an airflow from the compressor section to the turbine engine combustor, and (b) restricts an airflow from flowing from the ramjet bleed air passages to the turbine engine combustor, and, in the second operating state, (c) provides a ramjet inlet bleed airflow from the at least one ramjet bleed air passage to the turbine engine combustor, and (v) at least one accessory gearbox drivingly connected with the compressor section and including at least one accessory component that is driven accessory gearbox, the method comprising, in the first operating state, (a) actuating the turbine engine inlet section restriction device to provide the inlet airflow to the turbine engine inlet, (b) actuating the combustor inlet flow control device to provide the airflow from the compressor section to the turbine engine combustor, and to restrict the ramjet inlet bleed airflow from flowing through the ramjet bleed air passages to the turbine engine combustor, and (c) providing fuel to the turbine engine combustor to generate turbine engine combustion to drive the turbine section, and to provide turbine engine propulsion, and in the second operating state, (d) actuating the turbine engine inlet section restriction device to restrict the inlet airflow from flowing to the turbine engine inlet, (e) actuating the combustor inlet flow control device to restrict the airflow from flowing from the compressor section to the turbine engine combustor, and to provide the ramjet inlet bleed airflow to flow through the ramjet bleed air passages to the turbine engine combustor, (f) providing fuel to the turbine engine combustor to generate turbine engine combustion that drives the turbine section and also drives the compressor section, (g) driving, by the compressor section, the at least one accessory gearbox to operate the least one accessory component, and (h) providing fuel to the ramjet combustor to provide ramjet engine propulsion.

The method according to any preceding clause, the propulsion system further including a heat exchanger arranged in the ramjet inlet portion and arranged to cool a portion of a ramjet inlet airflow, the method further comprising, in the second operating state, providing a flow of cooled inlet air that is generated by the heat exchanger to the turbine engine inlet.

The method according to any preceding clause, the combustor inlet flow control device comprising an airflow bleed valve arranged at a downstream end of the compressor section, the airflow bleed valve including a ramjet bleed air inlet passage, a compressor bleed air outlet passage, and a flow control device, the method further comprising in the first operating state, actuating the flow control device to close the ramjet bleed air inlet passage and to open the compressor bleed air outlet passage, and, in the second operating state, actuating the flow control device to open the ramjet bleed air inlet passage so as to permit the ramjet inlet bleed airflow to flow through the combustor inlet flow control device to the turbine engine combustor and to close the compressor bleed air outlet passage.

A propulsion system comprising a ramjet engine, a turbine engine, and a combustor inlet flow control device. The ramjet engine includes a ramjet inlet portion and a ramjet bleed air passage, the ramjet inlet portion configured to receive a ramjet inlet airflow. The turbine engine includes a turbine engine inlet, a compressor section, a turbine engine combustor, and a turbine section, the turbine engine combustor being in airflow communication with the ramjet bleed air passage. The combustor inlet flow control device comprises a bleed valve arranged at an outlet end of the compressor section. The bleed valve includes a ramjet bleed air inlet, a compressor bleed air outlet, and a flow control device rotatable between: a first position in which the flow control device restricts the ramjet bleed air inlet and allows a flow of compressor bleed air through the compressor bleed air outlet to the turbine engine combustor; and a second position in which the flow control device restricts the compressor bleed air outlet and allows a flow of ramjet bleed air through the ramjet bleed air inlet to the turbine engine combustor.

The propulsion system according to the preceding clause, wherein the turbine engine comprises a high-pressure compressor, and the outlet end of the compressor section is an outlet end of the high-pressure compressor.

The propulsion system according to any preceding clause, wherein the combustor inlet flow control device is arranged at the outlet end of the high-pressure compressor.

The propulsion system according to any preceding clause, wherein the turbine engine combustor is configured to receive compressor bleed air in a first operating state of the propulsion system and to receive ramjet bleed air in a second operating state of the propulsion system.

The propulsion system according to any preceding clause, wherein in the first position, the flow control device allows compressor bleed air to flow to the turbine engine combustor via the compressor bleed air outlet.

The propulsion system according to any preceding clause, wherein in the second position, the flow control device restricts compressor bleed air from flowing through the compressor bleed air outlet.

The propulsion system according to any preceding clause, wherein the flow control device is a valve plate.

The propulsion system according to any preceding clause, wherein the flow control device is part of a compressor bleed air system.

The propulsion system according to any preceding clause, wherein the flow control device is arranged to be rotated between the first position and the second position during a transition between a low-speed operating state and a high-speed operating state.

The propulsion system according to any preceding clause, wherein the flow control device is configured to switch between the first and second positions based on a pressure differential between the ramjet bleed air inlet and the compressor section.

A method of regulating airflow to a turbine engine combustor of a turbine engine by a combustor inlet flow control device. The method comprises positioning a flow control device of the combustor inlet flow control device to a first operating state position to restrict a ramjet bleed air inlet passage and permit flow of compressor bleed air through a compressor bleed air outlet passage; and positioning the flow control device of the combustor inlet flow control device to a second operating state position to restrict the compressor bleed air outlet passage and to permit flow of ramjet bleed air through the ramjet bleed air inlet passage.

The method according to the preceding clause, further comprising combusting fuel in the turbine engine combustor with compressor bleed air when the flow control device is disposed in the first operating state position.

The method according to any preceding clause, further comprising combusting fuel in the turbine engine combustor with ramjet bleed air when the flow control device is in the second operating state position.

The method according to any preceding clause, further comprising blocking the ramjet bleed air inlet passage when the flow control device is disposed in the first operating state position.

The method according to any preceding clause, further comprising blocking the compressor bleed air outlet passage when the flow control device is disposed in the second operating state position.

The method according to any preceding clause, further comprising operating a ramjet engine including a ramjet inlet portion and a ramjet bleed air passage that supplies the ramjet bleed air to the combustor inlet flow control device.

The method according to any preceding clause, further comprising rotating the flow control device between the first operating state position and the second operating state position during a transition between a low-speed operating state and a high-speed operating state.

The method according to any preceding clause, further comprising driving a turbine section of the turbine engine using combustion gases generated by combustion in the turbine engine combustor.

The method according to any preceding clause, further comprising rotating a compressor section of the turbine engine and driving an accessory gearbox using the turbine section when the flow control device is disposed in the second operating state position.

A propulsion system comprising a ramjet engine, a turbine engine, and a combustor inlet flow control device. The ramjet engine includes a ramjet inlet portion and a ramjet bleed air passage, the ramjet inlet portion configured to receive a ramjet inlet airflow. The turbine engine includes a turbine engine inlet, a high-pressure compressor, a turbine engine combustor, and a turbine section, the turbine engine combustor being in airflow communication with the ramjet bleed air passage. The combustor inlet flow control device comprises a bleed valve arranged at an outlet end of the high-pressure compressor. The bleed valve includes a ramjet bleed air inlet, a compressor bleed air outlet, and a valve plate rotatable between: a first position in which the valve plate restricts the ramjet bleed air inlet and allows compressor bleed air to flow through the compressor bleed air outlet to the turbine engine combustor to form a fuel and air mixture for combustion in the turbine engine combustor; and a second position in which the valve plate restricts the compressor bleed air outlet and allows ramjet bleed air to flow through the ramjet bleed air inlet to the turbine engine combustor to form a fuel and air mixture for combustion in the turbine engine combustor.

Although the foregoing description is directed to some exemplary embodiments of the present disclosure, other variations and modifications will be apparent to those skilled in the art, and may be made without departing from the spirit or the scope of the disclosure. Moreover, features described in connection with one embodiment of the present disclosure may be used in conjunction with other embodiments, even if not explicitly stated above.

What is claimed is:

1. A propulsion system comprising:
a ramjet engine including a ramjet inlet portion and a ramjet bleed air passage, the ramjet inlet portion configured to receive a ramjet inlet airflow;
a turbine engine including a turbine engine inlet, a compressor section, a turbine engine combustor, and a turbine section, the turbine engine combustor being in airflow communication with the ramjet bleed air passage; and
a combustor inlet flow control device comprising a bleed valve arranged at an outlet end of the compressor section, the bleed valve including a ramjet bleed air inlet, a compressor bleed air outlet, and a flow control device rotatable between:
a first position in which the flow control device restricts the ramjet bleed air inlet and allows a flow of compressor bleed air through the compressor bleed air outlet to the turbine engine combustor; and
a second position in which the flow control device restricts the compressor bleed air outlet and allows a flow of ramjet bleed air through the ramjet bleed air inlet to the turbine engine combustor.

2. The propulsion system of claim 1, wherein the turbine engine comprises a high-pressure compressor, and the outlet end of the compressor section is an outlet end of the high-pressure compressor.

3. The propulsion system of claim 2, wherein the combustor inlet flow control device is arranged at the outlet end of the high-pressure compressor.

4. The propulsion system of claim 1, wherein the turbine engine combustor is configured to receive compressor bleed air in a first operating state of the propulsion system and to receive ramjet bleed air in a second operating state of the propulsion system.

5. The propulsion system of claim 1, wherein in the first position, the flow control device allows compressor bleed air to flow to the turbine engine combustor via the compressor bleed air outlet.

6. The propulsion system of claim 1, wherein in the second position, the flow control device restricts compressor bleed air from flowing through the compressor bleed air outlet.

7. The propulsion system of claim 1, wherein the flow control device is a valve plate.

8. The propulsion system of claim 1, wherein the flow control device is part of a compressor bleed air system.

9. The propulsion system of claim 1, wherein the flow control device is arranged to be rotated between the first position and the second position during a transition between a low-speed operating state and a high-speed operating state.

10. The propulsion system of claim 1, wherein the flow control device is configured to switch between the first and second positions based on a pressure differential between the ramjet bleed air inlet and the compressor section.

11. A method of regulating airflow to a turbine engine combustor of a turbine engine by a combustor inlet flow control device, the method comprising:
positioning a flow control device of the combustor inlet flow control device to a first operating state position to restrict a ramjet bleed air inlet passage and permit flow of compressor bleed air through a compressor bleed air outlet passage; and
positioning the flow control device of the combustor inlet flow control device to a second operating state position to restrict the compressor bleed air outlet passage and to permit flow of ramjet bleed air through the ramjet bleed air inlet passage.

12. The method of claim 11, further comprising combusting fuel in the turbine engine combustor with compressor bleed air when the flow control device is disposed in the first operating state position.

13. The method of claim 11, further comprising combusting fuel in the turbine engine combustor with ramjet bleed air when the flow control device is disposed in the second operating state position.

14. The method of claim 11, further comprising blocking the ramjet bleed air inlet passage when the flow control device is disposed in the first operating state position.

15. The method of claim 11, further comprising blocking the compressor bleed air outlet passage when the flow control device is disposed in the second operating state position.

16. The method of claim 11, further comprising operating a ramjet engine including a ramjet inlet portion and a ramjet bleed air passage that supplies the ramjet bleed air to the combustor inlet flow control device.

17. The method of claim 11, further comprising rotating the flow control device between the first operating state position and the second operating state position during a transition between a low-speed operating state and a high-speed operating state.

18. The method of claim 11, further comprising driving a turbine section of the turbine engine using combustion gases generated by combustion in the turbine engine combustor.

19. The method of claim 18, further comprising rotating a compressor section of the turbine engine and driving an accessory gearbox using the turbine section when the flow control device is disposed in the second operating state position.

20. A propulsion system comprising:
a ramjet engine including a ramjet inlet portion and a ramjet bleed air passage, the ramjet inlet portion configured to receive a ramjet inlet airflow;
a turbine engine including a turbine engine inlet, a high-pressure compressor, a turbine engine combustor, and a turbine section, the turbine engine combustor being in airflow communication with the ramjet bleed air passage; and
a combustor inlet flow control device comprising a bleed valve arranged at an outlet end of the high-pressure compressor, the bleed valve including a ramjet bleed air inlet, a compressor bleed air outlet, and a valve plate rotatable between:
a first position in which the valve plate restricts the ramjet bleed air inlet and allows compressor bleed air to flow through the compressor bleed air outlet to the turbine engine combustor to form a fuel and air mixture for combustion in the turbine engine combustor; and
a second position in which the valve plate restricts the compressor bleed air outlet and allows ramjet bleed air to flow through the ramjet bleed air inlet to the turbine engine combustor to form a fuel and air mixture for combustion in the turbine engine combustor.
